(19) United States
(12) Patent Application Publication
(10) Pub. No.: US 2026/0048589 A1
(43) Pub. Date: Feb. 19, 2026

(54) LIQUID SUPPLY UNIT AND LIQUID EJECTION DEVICE

(71) Applicant: SEIKO EPSON CORPORATION, Tokyo (JP)

(72) Inventors: Chikashi NAKAMURA, AZUMINO-SHI (JP); Satoru KOBAYASHI, SHIOJIRI-SHI (JP)

(21) Appl. No.: 19/302,694

(22) Filed: Aug. 18, 2025

(30) Foreign Application Priority Data
Aug. 19, 2024 (JP) 2024-137638

(51) Int. Cl. B41J 2/175

(52) U.S. Cl. CPC B41J 2/17523; B41J 2/17553; B41J 2/17566; B41J 2/17596

(57) ABSTRACT

A liquid supply unit includes a liquid storage section configured to store liquid; a supply flow path through which liquid in the liquid storage section flows out; an opening and closing section for opening and closing the supply flow path; and a posture change section that changes a posture of the liquid storage section depending on a remaining amount of liquid in the liquid storage section, wherein the opening and closing section opens and closes the supply flow path in accordance with a change in a posture of the liquid storage section.

The present application is based on, and claims priority from JP Application Serial Number 2024-137638, filed Aug. 19, 2024, the disclosure of which is hereby incorporated by reference herein in its entirety.

### BACKGROUND

### 1. Technical Field

The present disclosure relates to a liquid supply unit and a liquid ejection device including the liquid supply unit.

### 2. Related Art

For example, JP-A-2016-193616 discloses an ink supply device that is an example of a liquid supply unit. The ink supply device includes an ink container, which is an example of a liquid storage section, an ink flow path, which is an example of a supply flow path, and a float valve. The ink container contains ink introduced from an ink inlet port. The ink container feeds ink from a communication port to the ink flow path.

The float valve is provided in the ink container. The float valve opens the communication port by floating when the ink container is sufficiently filled with ink. The float valve closes the communication port when the remaining amount of ink becomes low.

The ink supply device of JP-A 2016-193616 sucks liquid from the liquid storage section by applying a negative pressure to the ink flow path. Therefore, the float valve closing the communication port may stick to the communication port. In order to open the ink flow path, it is necessary to generate a buoyancy larger than a negative pressure of the ink flow path in the float valve. However, in a case where a buoyancy is increased by increasing the size of the float valve, a configuration for positioning the float valve in the ink container is required, and thus there is a possibility that the configuration may become complicated.

### SUMMARY

A liquid supply unit for overcoming the above-described problem includes a liquid storage section configured to store liquid; a supply flow path through which liquid in the liquid storage section flows out; an opening and closing section for opening and closing the supply flow path; and a posture change section that changes a posture of the liquid storage section depending on a remaining amount of liquid in the liquid storage section, wherein the opening and closing section opens and closes the supply flow path in accordance with a change in a posture of the liquid storage section.

A liquid ejection device for overcoming the above-described problem includes the above-described liquid supply unit and a liquid ejection section configured to eject liquid.

### BRIEF DESCRIPTION OF THE DRAWINGS

FIG. 1 is a schematic diagram of a liquid ejection device.

FIG. 2 is a perspective view of a liquid supply unit.

FIG. 3 is a cross-sectional view of the liquid supply unit.

FIG. 4 is a perspective view of a supply flow path.

FIG. 5 is a perspective view of an opening and closing section.

FIG. 6 is a cross-sectional view of a liquid storage section.

FIG. 7 is a perspective view of the liquid storage section and the opening and closing section in a supply posture.

FIG. 8 is a cross-sectional view of the liquid storage section.

FIG. 9 is a perspective view of the liquid storage section and the opening and closing section in a closing posture.

### DESCRIPTION OF EMBODIMENTS

### Embodiment

Hereinafter, an embodiment of a liquid supply unit and a liquid ejection device will be described with reference to the drawings. The liquid ejection device is, for example, an inkjet type printer that performs printing by ejecting ink, which is an example of liquid, onto a medium such as a paper sheet, fabric, vinyl, plastic components, or metal components.

### Liquid Ejection Device

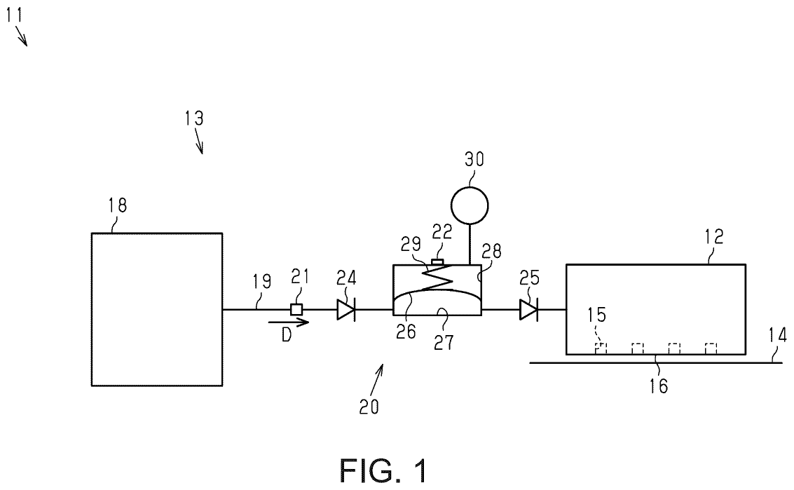

As shown in FIG. 1, a liquid ejection device 11 includes a liquid ejection section 12 and a liquid supply unit 13.

The liquid ejection section 12 is capable of ejecting liquid. The liquid ejection section 12 performs printing on a medium 14 by ejecting liquid onto the medium 14. The liquid ejection section 12 includes a nozzle surface 16 in which one or more nozzles 15 are opened. The liquid ejection section 12 ejects liquid from the nozzles 15.

### Liquid Supply Unit

The liquid supply unit 13 may include a liquid storage section 18, a supply flow path 19, a supply pump 20, a first detection section 21 that is an example of a detection section, and a second detection section 22 that is an example of a detection section.

The liquid storage section 18 is capable of storing liquid.

The supply flow path 19 is connected to the liquid storage section 18 at an end on an upstream side in a supply direction D. Liquid in the liquid storage section 18 flows out to the supply flow path 19. The supply flow path 19 is connected to the liquid ejection section 12 at an end on a downstream side in the supply direction D. The supply flow path 19 supplies liquid stored in the liquid storage section 18 to the liquid ejection section 12.

The supply pump 20 is provided in the supply flow path 19. The supply pump 20 supplies liquid sucked from the liquid storage section 18 to the liquid ejection section 12. The supply pump 20 may include a first one-way valve 24, a second one-way valve 25, a flexible membrane 26, a pump chamber 27, a pressure chamber 28, a spring 29, and a depressurization source 30.

The first one-way valve 24 is provided upstream of the pump chamber 27 in the supply direction D. The second one-way valve 25 is provided downstream of the pump chamber 27 in the supply direction D. The first one-way valve 24 and the second one-way valve 25 allow flow of liquid toward a downstream side in the supply direction D. The first one-way valve 24 and the second one-way valve 25 restrict flow of liquid toward an upstream side in the supply direction D.

The flexible membrane 26 separates the pump chamber 27 and the pressure chamber 28. The flexible membrane 26 has flexibility. The flexible membrane 26 changes the volume of the pump chamber 27 by being deformed depending on a difference in a pressure between the pump chamber 27 and the pressure chamber 28.

The spring 29 is provided in the pressure chamber 28. The spring 29 pushes the flexible membrane 26 in a direction to reduce the volume of the pump chamber 27.

The depressurization source 30 is capable of depressurizing the pressure chamber 28. The depressurization source 30 depressurizes the pressure chamber 28 to increase the volume of the pump chamber 27. When the volume of the pump chamber 27 increases, the supply pump 20 sucks liquid from the liquid storage section 18. When the depressurization source 30 releases the depressurization of the pressure chamber 28, the spring 29 pushes the flexible membrane 26. The spring 29 pushes out liquid in the pump chamber 27 by reducing the volume of the pump chamber 27. The depressurization source 30 drives the supply pump 20 by alternately depressurizing the pressure chamber 28 and releasing the depressurization.

The first detection section 21 may be provided in the supply flow path 19. The first detection section 21 detects a pressure between the liquid storage section 18 and the supply pump 20.

The second detection section 22 may be provided in the supply pump 20. The second detection section 22 detects displacement of the flexible membrane 26. The second detection section 22 indirectly detects a pressure upstream of the supply pump 20. Specifically, when the supply pump 20 is driven in a state where the supply of liquid from the liquid storage section 18 is stopped, a negative pressure upstream of the supply pump 20 increases. Therefore, even when the pressure chamber 28 is depressurized, the flexible membrane 26 cannot be displaced so as to increase the volume of the pump chamber 27. Therefore, by causing the second detection section 22 to detect displacement of the flexible membrane 26, it is possible to know whether or not the supply pump 20 is in a state of being supplied with liquid.

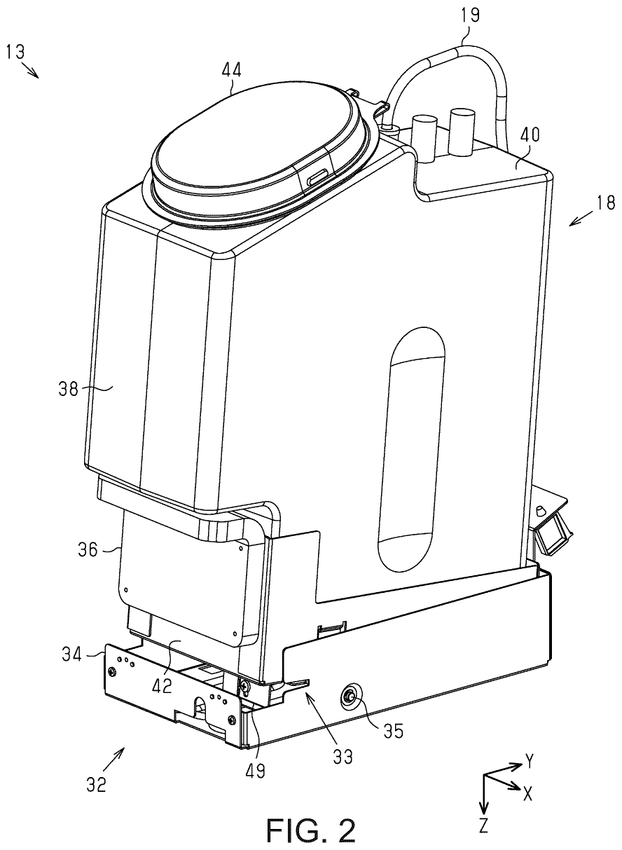

As shown in FIG. 2, in the drawing, a direction of gravity is indicated by a Z-axis and directions along a horizontal plane are indicated by an X-axis and a Y-axis, assuming that the liquid supply unit 13 is placed on the horizontal plane. The X-axis, the Y-axis, and the Z-axis are orthogonal to each other. In the following description, a direction parallel to the X-axis is also referred to as a width direction X, a direction parallel to the Y-axis is also referred to as a depth direction Y, and a direction parallel to the Z-axis is also referred to as a vertical direction Z.

The liquid supply unit 13 may include a posture change section 32 and a positioning section 33. The posture change section 32 changes a posture of the liquid storage section 18 depending on a remaining amount of liquid in the liquid storage section 18. The posture change section 32 may include a holder 34, a pivot shaft 35, and a weight 36.

The holder 34 holds the liquid storage section 18. The holder 34 may support the pivot shaft 35. The pivot shaft 35 may extend in the width direction X. The pivot shaft 35 pivotably supports the liquid storage section 18. That is, the liquid storage section 18 is supported by the holder 34 via the pivot shaft 35. The liquid storage section 18 is capable of changing a posture by pivoting about the pivot shaft 35 as a fulcrum. Pivot refers to rotation about an axis, and refers to rotation in which a rotatable angle is less than 360 degrees.

The positioning section 33 may be provided on the holder 34. The positioning section 33 defines a range in which a posture of the liquid storage section 18 changes. The positioning section 33 defines a range in which the liquid storage section 18 pivots.

### Liquid Storage Section

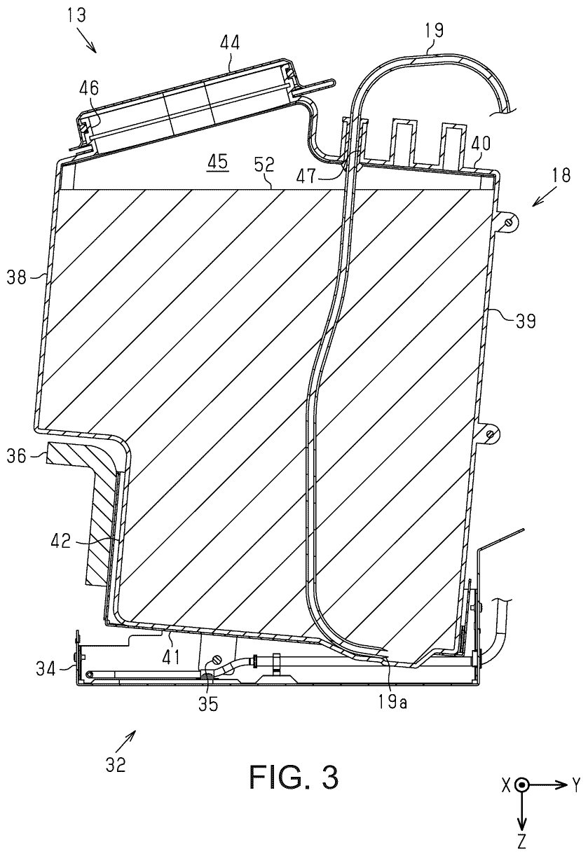

As shown in FIG. 3, the liquid storage section 18 may include a front wall 38, a rear wall 39, an upper wall 40, a bottom wall 41, and a recessed section 42.

The front wall 38 is a wall positioned on a front side in the depth direction Y. The rear wall 39 is a wall positioned on a rear side in the depth direction Y. The upper wall 40 is a wall positioned on an upper side in the vertical direction Z. The bottom wall 41 is a wall positioned on a lower side in the vertical direction Z. The recessed section 42 is a portion recessed rearward in the depth direction Y with respect to the front wall 38 and upward in the vertical direction Z with respect to the bottom wall 41.

The weight 36 may be attached to the liquid storage section 18. The weight 36 may be positioned in the recessed section 42. The weight 36 may be positioned rearward of the front wall 38. The weight 36 may be positioned above the bottom wall 41.

The liquid storage section 18 may include a lid 44, a storage chamber 45, an inlet port 46, and a supply port 47.

The lid 44 is provided so as to be movable between a closed position where the inlet port 46 is closed and an opened position where the inlet port 46 is opened. When the lid 44 is positioned at the opened position, liquid can be introduced from the inlet port 46. When the lid 44 is provided to be pivotable about a rear end in the depth direction Y, liquid is easily introduced into the inlet port 46 from the front.

The storage chamber 45 is capable of storing liquid introduced from the inlet port 46. The supply flow path 19 may be formed of a tube. The supply flow path 19 may be connected to the liquid storage section 18 by being inserted into the storage chamber 45 from the supply port 47. The inlet port 46 and the supply port 47 may be provided in the upper wall 40. The liquid storage section 18 may hold the upstream end 19a of the inserted supply flow path 19 at a bottom of the storage chamber 45. For example, a groove into which the supply flow path 19 is fitted may be formed in the bottom of the storage chamber 45.

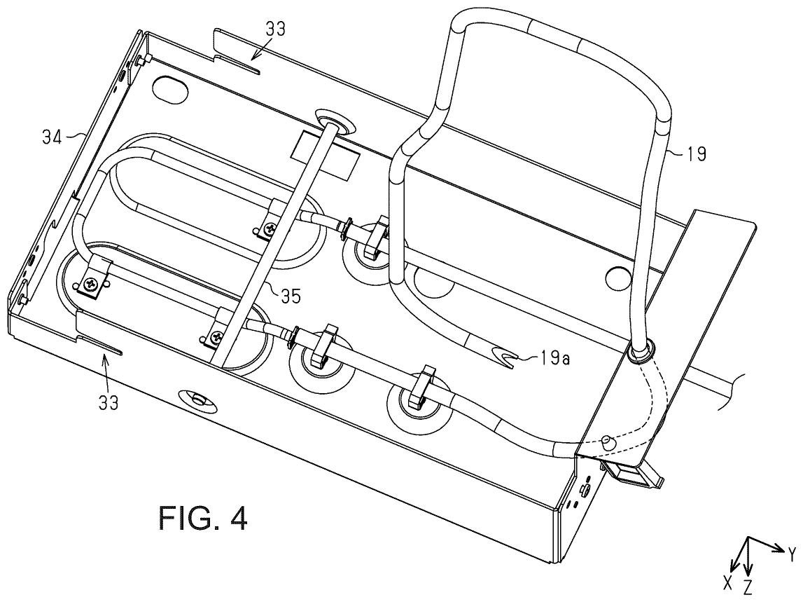

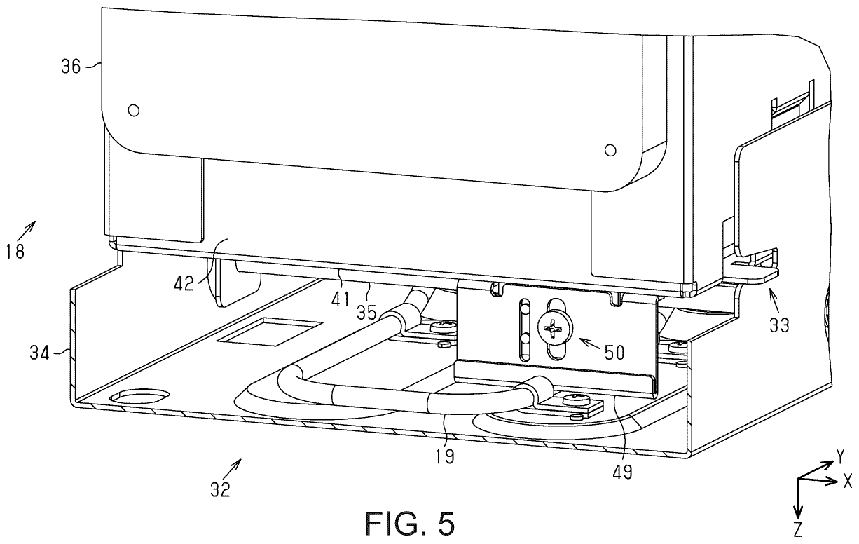

As shown in FIGS. 4 and 5, a portion of the supply flow path 19 positioned outside the storage chamber 45 may pass under the liquid storage section 18. The supply flow path 19 may pass under the pivot shaft 35. The holder 34 may hold the supply flow path 19.

As shown in FIG. 5, the liquid supply unit 13 may include an opening and closing section 49 and a position adjustment section 50.

The opening and closing section 49 is provided on the liquid storage section 18. The opening and closing section 49 may be provided on the bottom wall 41. The opening and closing section 49 may protrude downward from the bottom wall 41. The opening and closing section 49 is displaced in accordance with a change in a posture of the liquid storage section 18. The opening and closing section 49 is capable of opening and closing the supply flow path 19. The opening and closing section 49 may be provided at a position between the pivot shaft 35 and the weight 36 in the depth direction Y. The opening and closing section 49 opens and closes the supply flow path 19 at a position between the pivot shaft 35 and the weight 36.

The position adjustment section 50 can adjust a position of the opening and closing section 49 with respect to the liquid storage section 18 in a direction in which the opening and closing section 49 pivots. The position adjustment section 50 may be configured by, for example, an elongated hole formed in the opening and closing section 49 and a screw. The position adjustment section 50 can change the length from a leading edge of the opening and closing section 49 to the bottom wall 41.

### Operation of Present Embodiment

An operation of the present embodiment will be described.

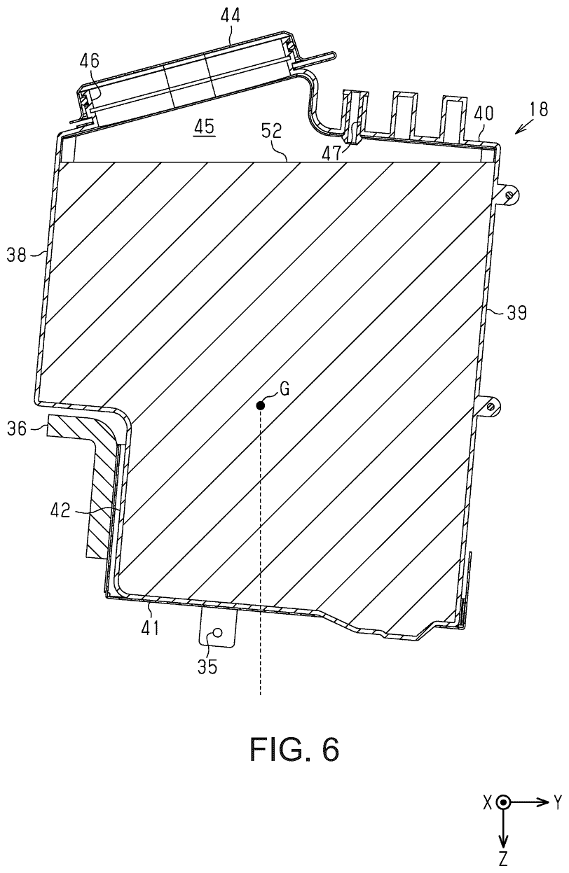

As shown in FIG. 6, centroid G of the liquid storage section 18 changes depending on a remaining amount of stored liquid. When a remaining amount is large, the centroid G is positioned behind the pivot shaft 35 in the depth direction Y. Therefore, the liquid storage section 18 takes a supply posture in which the rear wall 39 is lowered and the front wall 38 is raised. For example, when a liquid level 52 of liquid is positioned above the weight 36, the liquid storage section 18 takes the supply posture.

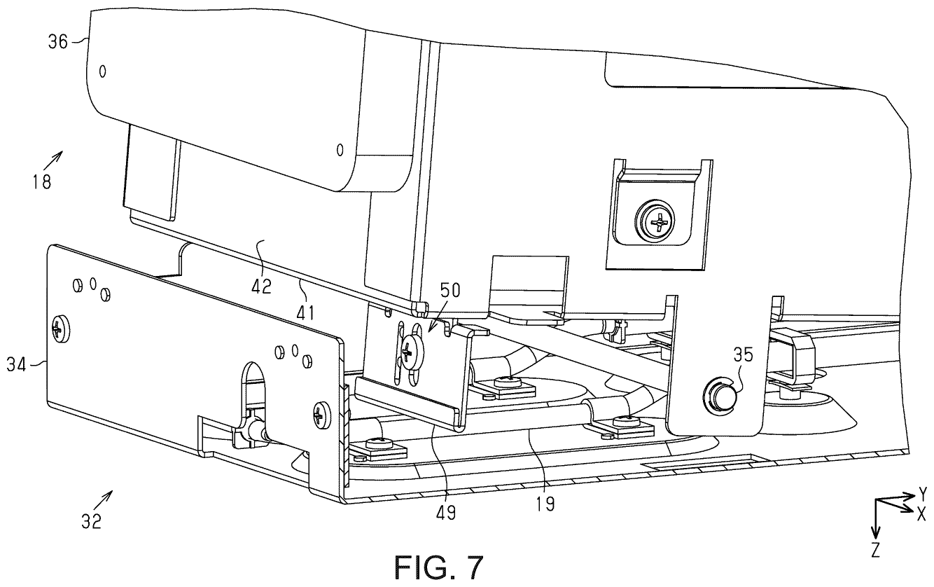

As shown in FIG. 7, when the liquid storage section 18 is in the supply posture, the opening and closing section 49 opens the supply flow path 19. That is, the supply flow path 19 is in a state where liquid can flow. The liquid storage section 18 in the supply posture can supply liquid.

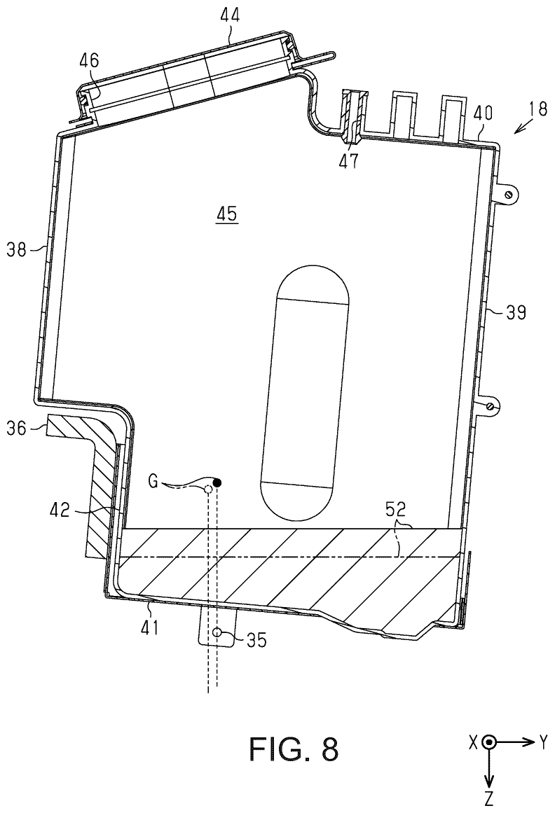

As shown in FIG. 8, when liquid is supplied from the liquid storage section 18 and a remaining amount of liquid decreases, the liquid level 52 is lowered. The centroid G of the liquid storage section 18 moves downward in the vertical direction Z and moves forward in the depth direction Y as a remaining amount decreases.

As indicated by two dot chain line in FIG. 8, when the liquid level 52 is further lowered, the centroid G exceeds the pivot shaft 35 in the depth direction Y. When the centroid G moves forward in the depth direction Y from the pivot shaft 35, the liquid storage section 18 pivots and changes its posture. That is, the liquid storage section 18 takes a closing posture in which the front wall 38 is lowered and the rear wall 39 is raised. The liquid storage section 18 pivots about the pivot shaft 35, which is a fulcrum, as a position of the centroid G of the liquid storage section 18 changes depending on a remaining amount. When the liquid storage section 18 is in the closing posture, the liquid level 52 is desirably positioned above the upstream end 19a of the supply flow path 19.

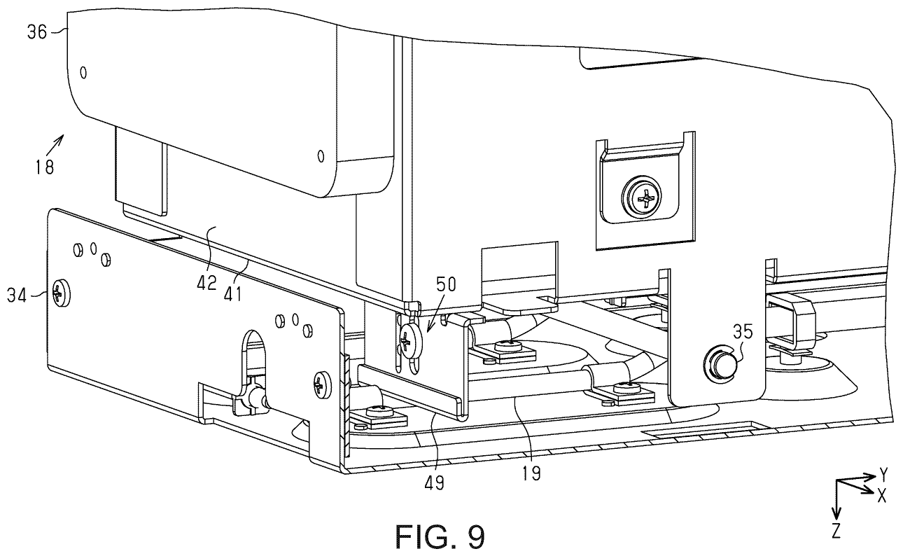

As shown in FIG. 9, when the liquid storage section 18 is in the closing posture, the opening and closing section 49 closes the supply flow path 19. The opening and closing section 49 presses and closes the supply flow path 19 by pivoting about the pivot shaft 35 that is a fulcrum together with the liquid storage section 18. The opening and closing section 49 of the present embodiment presses the supply flow path 19 passing under the opening and closing section 49 from above to close the supply flow path 19. The supply flow path 19 may be configured with a silicone tube at a portion that is pressed by the opening and closing section 49. The opening and closing section 49 may close the supply flow path 19 by flattening the silicone tube.

When the supply flow path 19 is closed, the supply of liquid from the liquid storage section 18 is stopped. The first detection section 21 detects a pressure between the supply pump 20 and the closing position where the opening and closing section 49 closes the supply flow path 19. The second detection section 22 indirectly detects a pressure between the closing position and the supply pump 20. The supply pump 20 is positioned downstream of the closing position in the supply direction D. The first detection section 21 and the second detection section 22 can detect a posture of the liquid storage section 18 by detecting a pressure between the closing position and the supply pump 20. When it is detected that the liquid storage section 18 is in the closing posture, the liquid ejection device 11 may prompt a user to refill liquid.

When the liquid storage section 18 in the closing posture is refilled with liquid, the liquid level 52 rises. The centroid G of the liquid storage section 18 moves upward in the vertical direction Z and rearward in the depth direction Y as a remaining amount increases.

As shown in FIG. 6, when the centroid G moves rearward in the depth direction Y from the pivot shaft 35, the liquid storage section 18 pivots and changes its posture. That is, the liquid storage section 18 takes a supply posture in which the rear wall 39 is lowered and the front wall 38 is raised. When the liquid storage section 18 is in the supply posture, the opening and closing section 49 opens the supply flow path 19. The opening and closing section 49 opens and closes the supply flow path 19 in accordance with a change in a posture of the liquid storage section 18.

### Effects of Present Embodiment

Effects of the present embodiment will be described.

(1-1) The posture change section 32 changes a posture of the liquid storage section 18 depending on a remaining amount of liquid. The opening and closing section 49 opens and closes the supply flow path 19 in accordance with a change in a posture of the liquid storage section 18. Therefore, since the liquid supply unit 13 opens and closes the supply flow path 19 depending on a remaining amount of liquid, a configuration of the liquid storage section 18 can be simplified.

(1-2) The liquid storage section 18 can easily change a posture by pivoting about a fulcrum. The posture change section 32 includes the weight 36. Therefore, a position of the centroid G of the liquid storage section 18 can be easily adjusted.

(1-3) The opening and closing section 49 pivots together with the liquid storage section 18. By causing the pivoting opening and closing section 49 to press the supply flow path 19, the supply flow path 19 can be quickly closed. Therefore, it is possible to reduce the possibility that air is sent from the liquid storage section 18 in which a remaining amount is small.

(1-4) The opening and closing section 49 provided on the liquid storage section 18 presses the supply flow path 19 from above to close the supply flow path 19. Therefore, the supply flow path 19 can be easily closed by using own weight of the liquid storage section 18 and the opening and closing section 49.

(1-5) The opening and closing section 49 is positioned at a position between a fulcrum and the weight 36. Therefore, the opening and closing section 49 can open the supply flow path 19 when a remaining amount is large, and can close the supply flow path 19 when the remaining amount is small.

(1-6) For example, when a user touches the weight 36 by mistake, the centroid G changes, and there is the possibility that the supply flow path 19 cannot be appropriately closed. In this regard, the weight 36 is positioned in the recessed section 42. Therefore, compared to a case where the weight 36 protrudes from the liquid storage section 18, it is possible to reduce a possibility that a user touches the weight 36.

(1-7) At least a part of the supply flow path 19 is configured with a silicone tube. The opening and closing section 49 can easily close the supply flow path 19 by pressing the silicone tube. The silicone tube is elastic and durable. Therefore, even when the opening and closing section 49 repeatedly presses the supply flow path 19, the opening and closing section 49 is separated from the supply flow path 19, and thus the supply flow path 19 can be opened.

(1-8) The position adjustment section 50 is capable of adjusting a position of the opening and closing section 49 in a direction in which the opening and closing section 49 pivots. Therefore, it is possible to easily adjust an amount of pressing of the supply flow path 19 by the pivoting opening and closing section 49.

(1-9) The positioning section 33 defines a range in which a posture of the liquid storage section 18 changes. Therefore, it is possible to reduce the possibility that a posture changes more than expected.

(1-10) The liquid storage section 18 includes the inlet port 46. A posture of the liquid storage section 18 changes depending on a remaining amount of liquid. Therefore, for example, a user can change a posture of the liquid storage section 18 by introducing liquid from the inlet port 46.

(1-11) The first detection section 21 detects a pressure of liquid between the closing position and the supply pump 20. When the opening and closing section 49 closes the supply flow path 19, a negative pressure increases between the closing position and the supply pump 20. Therefore, by causing the first detection section 21 to detect a pressure, it is possible to detect that the opening and closing section 49 has closed the supply flow path 19.

(1-12) The second detection section 22 detects displacement of the flexible membrane 26. When the opening and closing section 49 closes the supply flow path 19, the flexible membrane 26 cannot be displaced. Therefore, by causing the second detection section 22 to detect displacement of the flexible membrane 26, it is possible to detect that the opening and closing section 49 has closed the supply flow path 19.

### Modifications

The present embodiment can be implemented with the following modifications. The embodiments and the following modifications can be implemented in combination with each other as long as there is no technical contradiction.

The liquid supply unit 13 may be configured not to include at least one of the first detection section 21 and the second detection section 22.

The liquid supply unit 13 may include a posture detection section that directly detects a posture of the liquid storage section 18. When the liquid supply unit 13 detects that the liquid storage section 18 has been in the closing posture, the liquid supply unit 13 may stop the driving of the supply pump 20.

The liquid supply unit 13 may include a remaining amount detection section that detects a remaining amount of liquid stored in the liquid storage section 18. The posture change section 32 may change a posture of the liquid storage section 18 by, for example, pushing the liquid storage section 18 with a solenoid or the like or rotating the liquid storage section 18 with a motor or the like. The posture change section 32 may change the liquid storage section 18 to the closing posture when a remaining amount of liquid stored in the liquid storage section 18 in the supply posture is equal to or less than a threshold.

The liquid supply unit 13 may be configured not to include the supply pump 20. The liquid supply unit 13 may supply liquid by a water head.

The supply pump 20 may be a tube pump, a gear pump, a piston pump, or the like.

The liquid storage section 18 may not include the inlet port 46. The liquid storage section 18 may be a replaceable cartridge.

The liquid supply unit 13 may be configured not to include the positioning section 33.

The liquid supply unit 13 may be configured not to include the position adjustment section 50. The opening and closing section 49 may be configured integrally with the liquid storage section 18.

As long as a portion of the supply flow path 19 positioned at the closing position can be closed, the other portion may have rigidity. A portion of the supply flow path 19 positioned at the closing position may be configured with a rubber tube or an elastomer tube.

The weight 36 may be positioned at a position different from the recessed section 42. The weight 36 may be hung from the liquid storage section 18 by, for example, a string. The weight 36 may be provided on the bottom wall 41. The weight 36 may be provided on the upper wall 40. The weight 36 may be provided in the storage chamber 45. The liquid supply unit 13 may include a plurality of the weights 36 or may not include the weight 36.

When the liquid storage section 18 is in the supply posture, the distance between the opening and closing section 49 and the pivot shaft 35 may be longer than the distance between the weight 36 and the pivot shaft 35 in the depth direction Y.

The supply flow path 19 may be positioned at a position different from a position under the opening and closing section 49. The opening and closing section 49 may press the supply flow path 19 from a side to close the supply flow path 19. The opening and closing section 49 may press the supply flow path 19 from below to close the supply flow path 19.

The opening and closing section 49 may be provided separately from the liquid storage section 18. For example, when the liquid supply unit 13 detects that the liquid storage section 18 is in the closing posture, the liquid supply unit 13 may cause the opening and closing section 49 to close the supply flow path 19.

The opening and closing section 49 may be provided in the supply flow path 19. For example, the opening and closing section 49 may be a valve that is opened by being pressed. The opening and closing section 49 may open the supply flow path 19 by being pressed by the liquid storage section 18 in the supply posture. When the liquid storage section 18 is in the closing posture and is separated from the opening and closing section 49, the opening and closing section 49 may close the supply flow path 19.

The liquid ejection device 11 may be a liquid ejection device that sprays or ejects liquid other than ink. A state of liquid that is ejected from the liquid ejection device in a form of a minute amount of liquid droplets includes a granular shape, a tear shape, and a shape with a thread-like tail. Here, the liquid may be any material that can be ejected from the liquid ejection device. For example, the liquid may be in a state where a substance is in a liquid phase and includes a fluid body such as a liquid body having high or low viscosity, sol, gel water, other inorganic solvents, an organic solvent, a solution, a liquid resin, and a liquid metal (metal melt). The liquid includes not only a liquid as one state of a substance but also a liquid in which particles of a functional material made of a solid material such as a pigment or metal particles are dissolved, dispersed, or mixed in a solvent. Typical examples of the liquid include ink as described in the above embodiment and liquid crystal. Here, ink encompasses various liquid compositions such as general water-based ink, oil-based ink, gel ink, and hot-melt ink. As a specific example of the liquid ejection device, there is a device that ejects liquid containing, in a dispersed or dissolved form, a material such as an electrode material or a color material used for manufacturing a liquid crystal display, an electroluminescence display, a surface-emitting display, a color filter, or the like. The liquid ejection device may be a device that ejects a bioorganic substance used for manufacturing a biochip, a device that is used as a precision pipette and that ejects liquid serving as a sample, a textile printing device, a micro dispenser, or the like. The liquid ejection device may be a device that ejects lubricating oil in a pinpoint manner to precision machinery such as watches or cameras, or a device that ejects a transparent resin liquid, such as an ultraviolet curable resin, onto a substrate to form micro hemispherical lenses, optical lenses, or the like used in optical communication elements. The liquid ejection device may be a device for ejecting an etching liquid such as an acid or an alkali for etching a substrate or the like.

### Definitions

As used herein, the expression “at least one” means “one or more” of the desired options. As an example, the expression “at least one” as used herein means “only one option” or “both of two options” if the number of options is two. As another example, the expression “at least one” as used herein means “only one option”, “a combination of two optional options”, or “a combination of three or more optional options” when the number of options is three or more.

### Notes

Hereinafter, technical ideas grasped from the above-described embodiment and modifications, and operations and effects thereof will be described.

(1) A liquid supply unit includes a liquid storage section configured to store liquid; a supply flow path through which liquid in the liquid storage section flows out; an opening and closing section for opening and closing the supply flow path; and a posture change section that changes a posture of the liquid storage section depending on a remaining amount of liquid in the liquid storage section, wherein the opening and closing section opens and closes the supply flow path in accordance with a change in a posture of the liquid storage section.

According to this configuration, the posture change section changes a posture of the liquid storage section depending on a remaining amount of liquid. The opening and closing section opens and closes the supply flow path in accordance with a change in a posture of the liquid storage section. Therefore, since the liquid supply unit opens and closes the supply flow path depending on a remaining amount of liquid, a configuration of the liquid storage section can be simplified.

(2) The liquid supply unit according to above-described (1) may be configured such that the posture change section includes a weight attached to the liquid storage section and the liquid storage section pivots about a fulcrum by changing a centroid position of the liquid storage section depending on the remaining amount.

According to this configuration, the liquid storage section can easily change a posture by pivoting about a fulcrum. The posture change section includes the weight. Therefore, a centroid position of the liquid storage section can be easily adjusted.

(3) The liquid supply unit according to above-described (2) may be configured such that the opening and closing section is provided on the liquid storage section, and presses and closes the supply flow path by pivoting about the fulcrum together with the liquid storage section.

According to this configuration, the opening and closing section pivots together with the liquid storage section. The supply flow path can be quickly closed by causing the pivoting opening and closing section to press the supply flow path. Therefore, it is possible to reduce the possibility that air is sent from the liquid storage section in which a remaining amount is small.

(4) The liquid supply unit according to above-described (3) may be configured such that the supply flow path passes under the opening and closing section and the opening and closing section closes the supply flow path by pressing the supply flow path from above.

According to this configuration, the opening and closing section provided on the liquid storage section presses the supply flow path from above to close the supply flow path. Therefore, the supply flow path can be easily closed by using own weight of the liquid storage section and the opening and closing section.

(5) The liquid supply unit according to any one of above-described (2) to (4) may be configured such that the opening and closing section opens and closes the supply flow path at a position between the fulcrum and the weight.

According to this configuration, the opening and closing section is positioned at a position between the fulcrum and the weight. Therefore, the opening and closing section can open the supply flow path when a remaining amount is large, and can close the supply flow path when the remaining amount is small.

(6) The liquid supply unit according to any one of above-described (2) to (5) may be configured such that the liquid storage section includes a recessed section and the weight is positioned in the recessed section.

For example, when a user touches the weight by mistake, the centroid changes, and there is the possibility that the supply flow path cannot be appropriately closed. In this regard, according to this configuration, the weight is positioned in the recessed section. Therefore, compared to a case where the weight protrudes from the liquid storage section, it is possible to reduce the possibility that a user touches the weight.

(7) The liquid supply unit according to above-described (3) or (4) may be configured such that the supply flow path is configured with a silicone tube at a portion that is pressed by the opening and closing section.

According to this configuration, at least a part of the supply flow path is configured with the silicone tube. The opening and closing section can easily close the supply flow path by pressing the silicone tube. The silicone tube is elastic and durable. Therefore, even when the opening and closing section repeatedly presses the supply flow path, the opening and closing section is separated from the supply flow path, and thus the supply flow path can be opened.

(8) The liquid supply unit according to any one of above-described (3), (4), and (7) may be configured such that the liquid supply unit further includes a position adjustment section configured to adjust a position of the opening and closing section with respect to the liquid storage section in a direction in which the opening and closing section pivots.

According to this configuration, the position adjustment section can adjust a position of the opening and closing section in a direction in which the opening and closing section pivots. Therefore, it is possible to easily adjust the amount of pressing of the supply flow path by the pivoting opening and closing section.

(9) The liquid supply unit according to any one of above-described (1) to (8) may be configured such that the liquid supply unit further includes a positioning section that defines a range in which a posture of the liquid storage section changes.

According to this configuration, the positioning section defines a range in which a posture of the liquid storage section changes. Therefore, it is possible to reduce the possibility that a posture changes more than expected.

(10) The liquid supply unit according to any one of above-described (1) to (9) may be configured such that the liquid storage section includes an inlet port configured to introduce liquid.

According to this configuration, the liquid storage section includes the inlet port. The liquid storage section changes its posture depending on a remaining amount of liquid. Therefore, for example, a user can change a posture of the liquid storage section by introducing liquid from the inlet port.

(11) The liquid supply unit according to any one of above-described (1) to (10) may be configured such that the liquid supply unit further includes a supply pump provided in the supply flow path and a detection section that detects a pressure between a closing position at which the opening and closing section closes the supply flow path and the supply pump.

According to this configuration, the detection section detects a pressure of liquid between the closing position and the supply pump. When the opening and closing section closes the supply flow path, a negative pressure increases between the closing position and the supply pump. Therefore, by causing the detection section to detect a pressure, it is possible to detect that the opening and closing section has closed the supply flow path.

(12) The liquid supply unit according to any one of above-described (1) to (11) may be configured such that the liquid supply unit further includes a supply pump provided in the supply flow path and including a flexible membrane and a detection section that detects displacement of the flexible membrane.

According to this configuration, the detection section detects displacement of the flexible membrane. When the opening and closing section closes the supply flow path, the flexible membrane cannot be displaced. Therefore, by causing the detection section to detect displacement of the flexible membrane, it is possible to detect that the opening and closing section has closed the supply flow path.

(13) A liquid ejection device includes the liquid supply unit according to any one of above-described (1) to (12) and a liquid ejection section configured to eject liquid.

According to this configuration, the same effects as those of the above-described liquid supply unit can be achieved.

What is claimed is:

1. A liquid supply unit comprising:
a liquid storage section configured to store liquid;
a supply flow path through which liquid in the liquid storage section flows out;
an opening and closing section for opening and closing the supply flow path; and
a posture change section that changes a posture of the liquid storage section depending on a remaining amount of liquid in the liquid storage section, wherein
the opening and closing section opens and closes the supply flow path in accordance with a change in a posture of the liquid storage section.

2. The liquid supply unit according to claim 1, wherein
the posture change section includes a weight attached to the liquid storage section and
the liquid storage section pivots about a fulcrum by changing a centroid position of the liquid storage section depending on the remaining amount.

3. The liquid supply unit according to claim 2, wherein
the opening and closing section is provided on the liquid storage section, and presses and closes the supply flow path by pivoting about the fulcrum together with the liquid storage section.

4. The liquid supply unit according to claim 3, wherein
the supply flow path passes under the opening and closing section and
the opening and closing section closes the supply flow path by pressing the supply flow path from above.

5. The liquid supply unit according to claim 3, wherein
the opening and closing section opens and closes the supply flow path at a position between the fulcrum and the weight.

6. The liquid supply unit according to claim 2, wherein
the liquid storage section includes a recessed section and the weight is positioned in the recessed section.

7. The liquid supply unit according to claim 3, wherein
the supply flow path is configured with a silicone tube at a portion that is pressed by the opening and closing section.

8. The liquid supply unit according to claim 3, further comprising:
a position adjustment section configured to adjust a position of the opening and closing section with respect to the liquid storage section in a direction in which the opening and closing section pivots.

9. The liquid supply unit according to claim 1, further comprising:
a positioning section that defines a range in which a posture of the liquid storage section changes.

10. The liquid supply unit according to claim 1, wherein
the liquid storage section includes an inlet port configured to introduce liquid.

11. The liquid supply unit according to claim 1, further comprising:
a supply pump provided in the supply flow path and
a detection section that detects a pressure between a closing position at which the opening and closing section closes the supply flow path and the supply pump.

12. The liquid supply unit according to claim 1, further comprising:
a supply pump provided in the supply flow path and including a flexible membrane and
a detection section that detects displacement of the flexible membrane.

13. A liquid ejection device comprising:
the liquid supply unit according to claim 1 and
a liquid ejection section configured to eject liquid.
